(19) United States
(12) Patent Application Publication
(10) Pub. No.: US 2022/0364524 A1
(43) Pub. Date: Nov. 17, 2022

(54) PISTON FOR AN INTERNAL COMBUSTION ENGINE

(71) Applicant: Mahle International GmbH, Stuttgart (DE)

(72) Inventor: Klaus Keller, Lorch (DE)

(21) Appl. No.: 17/767,876

(22) PCT Filed: Oct. 7, 2020
(86) PCT No.: PCT/EP2020/078156

§ 371 Date: Apr. 8, 2022

(30) Foreign Application Priority Data
Oct. 9, 2019 (DE) 102019215486.7

(51) Int. Cl. F02F 3/22

(52) U.S. Cl. CPC F02F 3/22; F02F 2003/0061

(57) ABSTRACT

A piston for an internal combustion engine may include a lower piston part, a combustion chamber bowl part, and a ring section part. The lower piston part, the combustion chamber bowl part, and the ring section part may be welded together. The piston may include a first ring collar arranged on the combustion chamber bowl part. The piston may include a second ring collar arranged on the ring section part. The first and second ring collar may abut on one another and separate a first air insultation chamber from a coolant channel.

### CROSS-REFERENCE TO RELATED APPLICATIONS

This application claims priority to International Patent Application No. PCT/EP2020/078156 filed on Oct. 7, 2020, and German Patent Application No. DE 10 2019 215 486.7 filed on Oct. 9, 2019, the contents of each of which are hereby incorporated by reference in their entirety.

### TECHNICAL FIELD

The present invention relates to a piston for an internal combustion engine comprising a lower piston part, a combustion chamber bowl part, and a ring section part. The invention furthermore relates to an internal combustion engine comprising at least one such piston.

### BACKGROUND

A generic multi-part piston for an internal combustion engine is known from WO 2007/031109 A1, consisting of a combustion chamber bowl part, a ring section part, and a lower piston part, which can be produced separately from one another and which can then be joined by means of a joining process. In the direction of the combustion chamber bowl part, the ring section part thereby has a rotationally symmetrical joining region, and in the direction of the lower piston part likewise at least one rotationally symmetrical joining region on the other hand, which correspond to joining regions of the combustion chamber bowl part and of the lower piston part. The ring section part has a radial web, which separates an air insulation chamber close to the combustion chamber bowl from a coolant channel distally from the combustion bowl. The known piston thereby has a total of four joining surfaces between the individual parts, which is complex, because the four joints have to be pretreated accordingly.

A piston of an internal combustion engine comprising a combustion chamber bowl part and a lower piston part is known from US 2018/0334992 A1, which are welded to one another via a welded connection and which limit a coolant channel. A ring collar, which protrudes in the direction of the combustion chamber bowl part and which divides the coolant channel, is thereby arranged on the lower piston part. This axial ring collar, however, requires extremely small tolerances during the manufacture of the piston, because it protrudes in the axial direction from the lower piston part to the combustion chamber bowl part and thus supports itself on the latter comparatively stiffly.

### SUMMARY

The present invention deals with the problem of specifying an improved or at least an alternative embodiment for a piston of the generic type, which overcomes in particular the disadvantages known from the prior art.

This problem is solved according to the invention by means of the subject matter of the independent claim(s). Advantageous embodiments are subject matter of the dependent claim(s).

The present invention is based on the general idea of forming a piston of a total of three parts, and to thereby not only provide a coolant channel between the individual parts, but also a first air insulation chamber, which provides for an improved heat management of the piston, in particular also a heat insulation in the region of the piston bottom, whereby a temperature of the piston can be kept high in this region during the operation, and the combustion can thus be improved, and which has only three joints due to a specific formation with ring collars. The piston according to the invention for an internal combustion engine thereby has a lower piston part, a combustion chamber bowl part, as well as a ring section part, which are welded to one another. A first ring collar, which protrudes in particular outwards (obliquely to the radial direction) and which can be deformed in a resilient or plastic manner, is thereby arranged on the combustion chamber bowl part, while a second ring collar, which protrudes in particular inwards or downwards to the lower piston part and which is stiffer, is arranged on the ring section part. The two ring collars can thereby have a lamellar cross section. When the piston is fully assembled, the first and the second ring collar abut on one another and separate the above-mentioned, ring-shaped first air insulation chamber from the coolant channel. By means of the two lamellar ring collars, which abut on one another in the case of an assembled piston, a three-part piston can be created, in the case of which each part is connected to the two other parts via only two joints each, whereby a total of only three joints are required, namely a first one between the lower piston part and the combustion chamber bowl part, a second one between the combustion chamber bowl part and the ring section part, and a third one between the ring section part and the lower piston part. A connection of the two ring collars to one another thereby does not take place via a separate joining, for example a welding, but only via an abutment on one another, preferably via a tight and pre-tensioned abutment on one another, whereby the separation between the first air insulation chamber close to the piston bottom and the coolant channel distally from the piston bottom is made possible by means of the two ring collars, which simply contact one another. A temperature of the piston in the region of a piston bottom can be kept comparatively high by means of the first air insulation chamber above the coolant channel, which has a positive impact on a combustion and thus an efficiency of an internal combustion engine equipped with a piston of this type.

In the case of an advantageous further development of the solution according to the invention, the first and the second ring collar abut on one another so as to overlap, tightly, and under pre-tension when the piston is fully assembled. A joint-free tight separation can thereby be attained between the first air insulation chamber and the coolant channel, so that a further joint, for example a welded joint, can be forgone at a contact region between the first and the second ring collar. This significantly simplifies the manufacture of the piston.

In the case of an advantageous further development of the solution according to the invention, the first ring collar protrudes outwards from the combustion chamber bowl part at an angle α obliquely to a piston axis, wherein the second ring collar protrudes inwards from the ring section part at an angle β obliquely to the piston axis or downwards from the ring section part to the lower piston part parallel to the piston axis. It is particularly preferred thereby, provided that the second ring collar is oriented obliquely downwards to the lower piston part, whereby an undercut results in the region of the ring section both in the region of the first air insulation chamber and in the region of the coolant channel, whereby a significantly improved cooling of the ring section can be attained. Purely theoretically, it goes without saying that a purely radial alignment of the two ring collars is also conceivable.

In the case of an advantageous further development of the solution according to the invention, the first ring collar has an, in particular ring-shaped, cross sectional reduction, which divides the first ring collar into a first portion connected to the combustion chamber bowl part and a cantilevered second portion. The cross sectional reduction represents a weak point thereby, analogously to a film hinge, whereby the cantilevered second portion experiences a significantly higher elasticity. During the assembly of the piston, this elasticity can be used for the purpose that the comparatively stiff second ring collar abuts tightly on the second portion of the first ring collar, which is slightly deformed due to its elasticity. The ring-shaped cross sectional reduction can transfer a disk spring-like effect to the cantilevered second portion of the first ring collar, so that the first ring collar abuts with its second portion on the second ring collar in an elastically pre-tensioned manner when the piston is fully assembled.

In the case of an advantageous further development of the solution according to the invention, the first ring collar has a larger radial extension (outwards) than the second ring collar (inwards). Due to the larger radial extension of the first ring collar and in particular also due to the cross sectional reduction, the elasticity of the first ring collar—even without the cross sectional reduction—is significantly larger than the elasticity of the second ring collar with the same thickness, wherein the second ring collar is comparatively stiff. During an assembly of the piston it can be attained thereby that the comparatively stiff second ring collar resiliently deflects the first ring collar or the second portion thereof, respectively,

In addition or in the alternative, it can also be provided that a piston bottom section of the ring section part extends radially farther inwards than the second ring collar, which significantly simplifies in particular a manufacture of the piston, because firstly the combustion chamber bowl part comprising the lower piston part and subsequently the ring section part can be coaxially attached to the combustion chamber bowl part and can be welded to one another for the manufacture.

In the alternative, it is also conceivable that the second ring collar has an, in particular ring-shaped, cross sectional reduction, which divides the second ring collar into a first portion connected to the ring section part and a cantilevered second portion. The cross sectional reduction represents a weak point thereby, analogously to a film hinge, whereby the cantilevered second portion experiences a significantly higher elasticity. During the assembly of the piston, this elasticity can be used for the purpose that the comparatively stiff first ring collar in this case abuts tightly on the second portion of the second ring collar, which is slightly deformed due to its elasticity. The ring-shaped cross sectional reduction can transfer a disk spring-like effect to the cantilevered second portion of the second ring collar, so that the second ring collar abuts with its second portion on the first ring collar in an elastically pre-tensioned manner when the piston is fully assembled.

In the case of an advantageous further development of the solution according to the invention, the second ring collar has a larger radial extension (inwards) than the first ring collar (outwards). Due to the larger radial extension of the second ring collar and in particular also due to the cross sectional reduction, the elasticity of the second ring collar—even without the cross sectional reduction—is significantly larger than the elasticity of the first ring collar with the same thickness. During an assembly of the piston it can be attained thereby that the comparatively stiff first ring collar resiliently deflects the second ring collar or the second portion thereof, respectively.

In addition or in the alternative, it can also be provided for the case described in the previous paragraph that a piston bottom section of the ring section part extends radially inwards to a lesser extent than the second ring collar, which in particular significantly simplifies a manufacture of the piston, because firstly the ring section part comprising the lower piston part and subsequently the combustion chamber bowl part can be coaxially inserted into the ring section part and attached to the lower combustion part and can be welded to one another for the manufacture.

A second air insulation chamber, which is separated from the first air insulation chamber and which is arranged coaxially within the first air insulation chamber and the coolant channel, is advantageously provided between the lower piston part and the combustion chamber bowl part. A temperature of the piston in the region of a piston bottom can be kept comparatively high by means of the second air insulation chamber in the dome region or combustion chamber bowl region, respectively, as well as the first air insulation chamber above the coolant channel, which has a positive impact on a combustion and thus an efficiency of an internal combustion engine equipped with a piston of this type. Due to the oblique alignment of the two ring collars, a reliable cooling of annular grooves of the ring section part can nonetheless be attained. A high-performance and simultaneously efficiency-optimized operation of an internal combustion engine is thus possible with the piston according to the invention.

In the case of an advantageous embodiment of the solution according to the invention, the lower piston part is made of a 42CrMo4 steel or of a 38MnVs6 steel. This provides for a more cost-efficient manufacture of the lower piston part. A 42CrMo4 steel is a tempering steel, which is suitable for hardening due to its chemical composition and which can have an improved toughness in the tempered state with simultaneously high tensile strength. A 38MnVs6 steel is more cost-efficient and is thus advantageous for a region of the piston, which does not need to meet any high requirements regarding strength.

A heat-resistant steel can be used for the combustion chamber bowl part, which is able to withstand the temperatures arising in the combustion chamber in a wear-free manner in the long term, whereby a high wear-resistance of the piston and thus also of an internal combustion engine equipped with such a piston can be attained. In particular a nickel-chromium alloy can be used here.

The present invention is further based on the general idea of equipping an internal combustion engine with a cylinder and at least one such piston, and to thus transfer the advantages described for a piston of this type to the internal combustion engine. The temperature of the combustion chamber bowl part can in particular be kept high in the long run by means of the air insulation chambers, and a combustion can thus be positively impacted, which likewise has a positive impact on the combustion process and thus the efficiency of the internal combustion engine.

Further important features and advantages of the invention follow from the subclaims, from the drawings, and from the corresponding figure description on the basis of the drawings.

It goes without saying that the above-mentioned features and the features, which will be described below, cannot only be used in the respective specified combination, but also in other combinations, or alone, without leaving the scope of the present invention.

Preferred exemplary embodiments of the invention are illustrated in the drawings and will be described in more detail in the following description, whereby identical reference numerals refer to identical or similar or functionally identical components.

### BRIEF DESCRIPTION OF THE DRAWINGS

In each case schematically,

FIG. 1 shows a sectional illustration through a piston according to the invention,

FIG. 2 shows a detailed illustration through a possible embodiment of a piston according to the invention in the region of the first and second ring collar,

FIG. 3 shows a detailed illustration as in FIG. 2, but in the case of another second ring collar.

### DETAILED DESCRIPTION

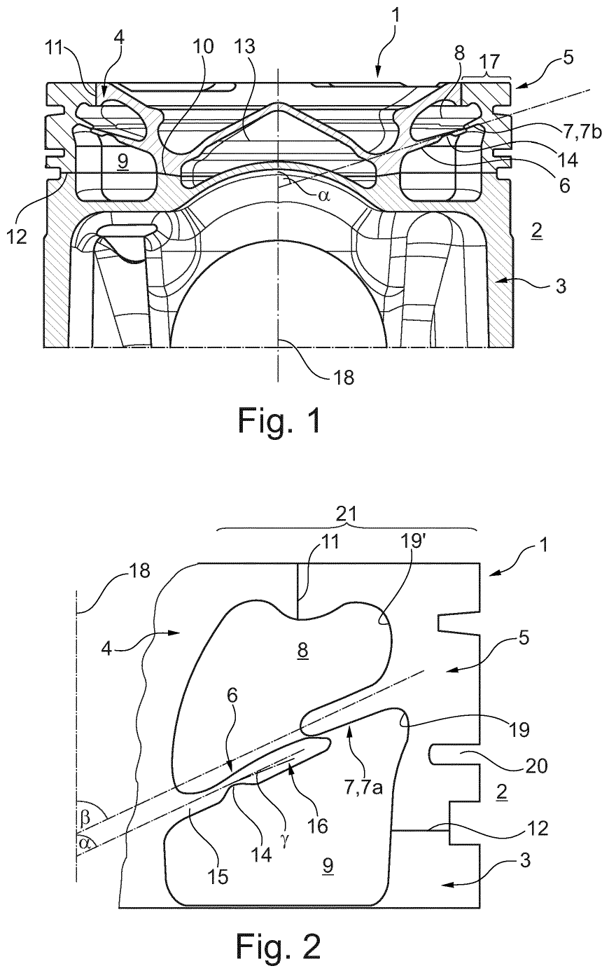

According to FIGS. 1 to 3, a piston 1 according to the invention of an internal combustion engine 2, which is likewise in accordance with the invention, has a lower piston part 3, a combustion chamber bowl part 4, as well as a ring section part 5, which are welded to one another. A first ring collar 6, which protrudes outwards (see in particular FIG. 2) is thereby arranged on the combustion chamber bowl part 4, while a second ring collar 7 is arranged on the ring section part 5. When the piston 1 is fully assembled, as it is illustrated according to FIG. 1, the first and second ring collar 6, 7 thereby abut on one another and separate a first air insulation chamber 8 from a coolant channel 9.

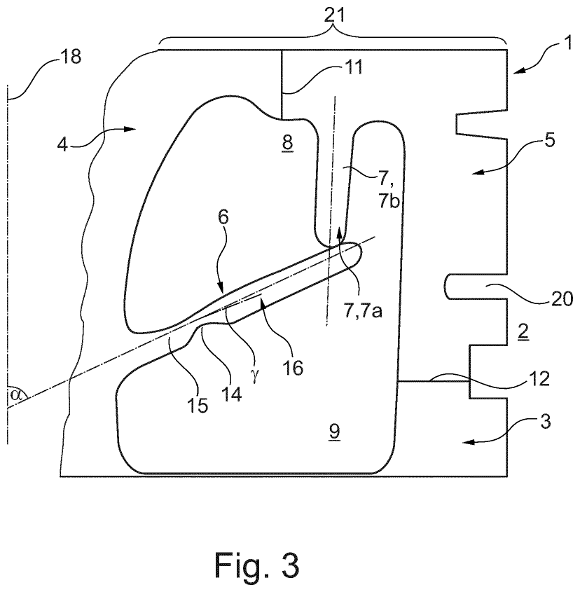

The second ring collar 7 can be formed as second ring collar 7a, which protrudes inwards from the ring section part 5 (see FIG. 2) or as second ring collar 7b, which protrudes downwards to the lower piston part 3 (see FIG. 3).

By means of the piston 1 according to the invention it is possible for the first time to create a piston 1 comprising a first air insulation chamber 8 and a coolant channel 9, which is separated therefrom, via only three joints 10, 11, 12, namely a first joint 10 between the lower piston part 3 and the combustion chamber bowl part 4, a second joint 11 between the combustion chamber bowl part and the ring section part 5, and a third joint 12 between the ring section part 5 and the lower piston part 3.

A second air insulation chamber 13, which is separated from the first air insulation chamber 8 and which is arranged coaxially within the first air insulation chamber 8 and the coolant channel 9, is furthermore provided between the lower piston part 3 and the combustion chamber bowl part 4. The second air insulation chamber 13 is thereby enclosed by the lower piston part 3 and the combustion chamber bowl part 4. A temperature of the combustion chamber bowl part 4 can be kept comparatively high via the two air insulation chambers 8 and 13, whereby the combustion in the combustion chamber of the internal combustion engine 2 as well as an efficiency of the internal combustion engine 2 can be optimized. The lower piston part 3, the internal combustion bowl part 4, as well as the ring section part 5 can thereby be welded to one another, for example via a laser welded joint or a friction welded joint at the individual joints 10, 11, 12.

When looking at the two ring collars 6, 7, 7a, 7b in more detail, it can be seen in particular in FIG. 2 that they abut on one another other so as to overlap, tightly, and preferably under pre-tension when the piston 1 is fully assembled, wherein the pre-tension can in particular also be attained by means of a different elasticity of the first ring collar 6 and of the second ring collar 7, 7a, 7b. The first ring collar 6 can thereby have a higher elasticity than the second ring collar 7, 7a, 7b, so that the second ring collar 7, 7a, 7b is formed to be stiffer compared to the first ring collar 6. According to FIG. 3, the second ring collar 7b protrudes downwards from the ring section part 5 to the lower piston part 3, and abuts on the first ring collar 6. The higher elasticity of the first ring collar 6 can be attained, for example, by means of a further collar width and, in the illustrated case, additionally by means of a ring-shaped cross sectional reduction 14, which divides the first ring collar 6 into a first portion 15 connected to the combustion chamber bowl part 4 and a cantilevered second portion 16. In response to a joining of the piston 1, the combustion chamber bowl part 4 is thus firstly attached to the lower piston part 3, and subsequently the ring section part 5 to the lower piston part 3. The comparatively stiff second ring collar 7, 7a, 7b thereby pushes the second portion 16 of the first ring collar 6 slightly downwards and thus deforms the second portion 16 of the first ring collar 6 elastically or plastically, and thus creates a tight and pre-tensioned connection between the first and second ring collar 6, 7, 7a, 7b, and thus a tight separation between the first air insulation chamber 8 and the coolant duct 9.

The first ring collar 6 can thereby have a larger radial extension than the second ring collar 7, 7a, 7b, whereby a comparatively simple attachment of the ring section part 5 to the lower piston part 3 can be attained during the joining of the piston 1. A piston bottom section 17 of the ring section part 5 thereby extends farther inwards than the second ring collar 7, 7a, 7b, whereby the axial attachment of the ring section part 5 to the lower piston part 3 is made possible in the case of an already available combustion chamber bowl part 4.

The first ring collar 6 thereby preferably protrudes from the combustion chamber bowl part 4 at an angle a obliquely to a piston axis 18, while the second ring collar 7, 7a protrudes from the ring section part 5 at an angle β obliquely to the piston axis 18. □ and β can thereby be equal, in particular have 45°. When the piston 1 is fully assembled, the second portion 16 of the first ring collar 6 can be bent to the first portion 15 of the first ring collar 6 by and angle γ, whereby the abutment of the two ring collars 6, 7, 7a or of the second portion 16, respectively, under pre-tension on the second ring collar 7, 7a is attained. The piston axis 18 is thereby delineated so as to be offset in the direction of the ring section 5 in FIG. 2, in order to clarify the angles α and (3. When the piston 1 is fully assembled, the angle γ is likely to be greater than 0, and the angles could thus be (a +y) >fr Prior to the assembly, the angle γ could equal 0, and the angles could thus be (α+γ)>β, for example.

When looking at the second ring collar 7, 7a according to FIGS. 1 and 2 once again, it can be seen that it extends inwards under the angle β and downwards in the direction of the lower piston part 3, whereby it goes without saying that a purely radial alignment to the piston axis 18 is also conceivable. Due to the inclined arrangement of the second ring collar 7, 7a, however, a recess 19 is possible, by means of which a distance between the coolant channel 9 and annular grooves 20 arranged in the ring section 5 can be decreased, and an improved cooling of the annular grooves 20 or piston rings arranged therein and not shown, respectively, can be attained.

A recess 19′ of this type is also conceivable in the first air insulation chamber 8 due to the obliquely arranged second ring collar 7, for example, whereby a more even temperature distribution in the region of a piston bottom 21 can be attained.

According to FIG. 3, the first ring collar 6, in turn, protrudes from the combustion chamber bowl part 4 at an angle a obliquely to a piston axis 18, while the second ring collar 7, 7b protrudes from the ring section part 5 parallel to the piston axis 18. In this case, β equals 0. No recesses 19, 19′ are drawn in this case, but it goes without saying that they could likewise be provided.

The lower piston part 3 can be made, for example, of a 42CrMo4 steel or a 38MnVs6 steel, wherein the combustion chamber bowl part 4 and/or the ring section part 5 can be made of a more heat-resistant steel and thus of a more high-quality steel, in order to be able to absorb the temperatures arising in a combustion chamber in a wear-free manner or at least in a low-wear manner, respectively, in the long term.

A significantly simplified joining of a three-part piston 1 can be attained by means of the piston 1 according to the invention and the internal combustion engine 2 according to the invention, with simultaneously provided first air insulation chamber 8 and coolant channel 9, in the same way as an improved temperature management, for example a more even and higher temperature in the region of the combustion chamber bowl part 4, and an improved cooling in the region of a lower region of the ring section part 5 and of the lower piston part 3. The piston 1 according to the invention can furthermore be manufactured by means of only a single joining process (e.g. laser welding), which is cost-efficient, because different systems are not required.

1. A piston for an internal combustion engine, comprising:
a lower piston part, a combustion chamber bowl part, and a ring section part welded to one another;
a first ring collar arranged on the combustion chamber bowl part;
a second ring collar arranged on the ring section part; and
wherein the first ring collar and the second ring collar abut on one another and separate a first air insulation chamber from a coolant channel.

2. The piston according to claim 1, wherein:
the first ring collar protrudes outwards from the combustion chamber bowl part; and
the second ring collar protrudes at least one of (i) inwards from the ring section part and (ii) downwards to the lower piston part.

3. The piston according to claim 1, further comprising a second air insulation chamber, wherein:
the second air insulation chamber is separated from the first air insulation chamber and is arranged coaxially within the first air insulation chamber and the coolant channel; and
the second air insulation chamber is disposed between the lower piston part and the combustion chamber bowl part.

4. The piston according to claim 2, wherein at least one of:
the first ring collar protrudes from the combustion chamber bowl part at a first angle and extends obliquely to a piston axis; and
the second ring collar protrudes from the ring section part at a second angle and extends one of obliquely and parallelly to the piston axis.

5. The piston according to claim 4, wherein at least one of:
the first angle is equal to the second angle; and
at least one of the first angle and the second angle is 45 degrees.

6. The piston according to claim 1, wherein:
the first ring collar includes a ring-shaped, cross-sectional reduction, which divides the first ring collar into a first portion connected to the combustion chamber bowl part and a cantilevered second portion.

7. The piston according to claim 6, wherein:
the first ring collar abuts with the second portion on the second ring collar in at least one of an elastically pre-tensioned manner and a plastically deformed manner.

8. The piston according to claim 1, wherein at least one of:
the first ring collar has a larger radial extension than the second ring collar; and
a piston bottom section of the ring section part extends radially farther inwards than the second ring collar.

9. The piston according to claim 1, wherein:
the first ring collar and the second ring collar abut on one another so as to overlap, tightly, and under pre-tension.

10. The piston according to claim 1, wherein:
the lower piston part, the internal combustion bowl part, and the ring section part are welded to one another via at least one of a laser welded joint and a friction welded joint.

11. The piston according to claim 1, wherein:
the lower piston part is composed of at least one of a 42CrMo4 steel and a 38MnVs6 steel.

12. The piston according to claim 3, wherein:
the first air insulation chamber is enclosed by the ring bowl part and the ring section part; and
that the second air insulation chamber is enclosed by the ring bowl part, the ring section part, and the lower piston part.

13. An internal combustion engine, comprising a cylinder and a piston, the piston including:
a lower piston part, a combustion chamber bowl part, and a ring section part welded to one another;
a first ring collar arranged on the combustion chamber bowl part;
a second ring collar arranged on the ring section part; and
wherein the first ring collar and the second ring collar abut on one another and separate a first air insulation chamber from a coolant channel.

14. A piston for an internal combustion engine, comprising:
a lower piston part, a combustion chamber bowl part, and a ring section part welded to one another;
a first ring collar arranged on the combustion chamber bowl part;
a second ring collar arranged on the ring section part;
wherein the first ring collar and the second ring collar abut on one another and separate a first air insulation chamber from a coolant channel;
wherein the first ring collar protrudes outwards from the combustion chamber bowl part;
wherein the second ring collar protrudes at least one of (i) inwards from the ring section part and (ii) downwards to the lower piston part;
wherein the first ring collar protrudes from the combustion chamber bowl part at a first angle and extends obliquely to a piston axis; and
the second ring collar protrudes from the ring section part at a second angle and extends one of obliquely and parallelly to the piston axis.

15. The piston of claim 14, wherein the first ring collar includes a ring-shaped, cross-sectional reduction, which divides the first ring collar into a first portion connected to the combustion chamber bowl part and a cantilevered second portion.

16. The piston of claim 14, wherein at least one of:
the first angle is equal to the second angle; and
at least one of the first angle and the second angle is 45 degrees.

17. The piston of claim 14, wherein:
the first ring collar includes a ring-shaped, cross-sectional reduction, which divides the first ring collar into a first portion connected to the combustion chamber bowl part and a cantilevered second portion; and
the first ring collar abuts with the second portion on the second ring collar in at least one of an elastically pre-tensioned manner and a plastically deformed manner.

18. The piston of claim 14, wherein:
the first ring collar has a larger radial extension than the second ring collar; and
a piston bottom section of the ring section part extends radially farther inwards than the second ring collar.

19. The piston of claim 14, further comprising a second air insulation chamber, wherein:
the second air insulation chamber is separated from the first air insulation chamber and is arranged coaxially within the first air insulation chamber and the coolant channel; and
the second air insulation chamber is disposed between the lower piston part and the combustion chamber bowl part.

20. The piston of claim 19, wherein:
the first air insulation chamber is enclosed by the ring bowl part and the ring section part; and
the second air insulation chamber is enclosed by the ring bowl part, the ring section part, and the lower piston part.
